(19) United States
(12) Patent Application Publication
(10) Pub. No.: US 2015/0028243 A1
(43) Pub. Date: Jan. 29, 2015

(54) VALVE WITH GROUNDED CLOSURE MEMBER

(71) Applicant: VAT Holding AG, Haag (CH)

(72) Inventors: Helmut Bernhart, Dornbirn (AT); Oliver Mahr, Schlins (AT)

(73) Assignee: VAT HOLDING AG, Haag (CH)

(21) Appl. No.: 14/333,936

(22) Filed: Jul. 17, 2014

(30) Foreign Application Priority Data
Jul. 23, 2013 (AT) A589/2013

(51) Int. Cl. F16K 3/02

(52) U.S. Cl. CPC F16K 3/02
USPC 251/318

(57) ABSTRACT

A valve with a closure member that, in its closed position, seals the through-opening, with the interposition of the seal against the valve seat, and is movable into the closed position by a relative movement between the closure member and the supporting member. The supporting member, in the closed position of the closure member, is supported on the abutment seat. The valve also has at least one grounding element for electrically grounding the closure member in its closed position, fastened on a carrier component of the valve. The carrier component is the closure member, the supporting member, the valve seat, or the abutment seat. The grounding element has a contact element and a supporting element, which is connected to the contact element, and the contact element and the supporting element are formed of mutually different materials or material compositions and the contact element is softer than the supporting element.

### INCORPORATION BY REFERENCE

The following documents are incorporated herein by reference as if fully set forth: Austrian patent application A589/2013, filed Jul. 23, 2013.

### BACKGROUND

The present invention relates to a valve, in particular vacuum valve, having at least one through-opening and at least one closure member and at least one seal and at least one supporting member and at least one valve seat and at least one abutment seat, wherein the closure member, in its closed position, seals the through-opening, with the interposition of the seal against the valve seat, and can be moved into the closed position by means of a relative movement between the closure member and the supporting member, wherein the supporting member, in the closed position of the closure member, is supported on the abutment seat and the valve, in addition, has at least one grounding element for electrically grounding the closure member in its closed position, wherein the grounding element is fastened on a carrier component of the valve and the carrier component is the closure member or the supporting member or the valve seat or the abutment seat.

In particular in vacuum technology, it is known for the closure member, which in its closed position closes the through-opening of the valve, to be grounded in the closed position so that it is not possible for the closure member to be subjected to undesired electrical charging and the unwanted byproducts associated therewith, e.g. electrical arcing and the like. A valve of the generic type is disclosed in EP 1 739 718 A1. The latter document proposes grounding elements consisting of electrically conductive elastomer in order to avoid a metal-on-metal connection and thus the risk of metal particles being introduced. This can indeed reduce the undesired introduction of particles into the process chamber, of which the through-opening is to be closed by means of the valve, however, it seems questionable as to how long this type of grounding is functional.

### SUMMARY

It is an object of the invention, therefore, to provide a valve of the aforementioned type which, in an alternative manner, allows the grounding of the closure member to function over a long period of time.

For this purpose, the invention provides for the grounding element to have at least one contact element and at least one supporting element, which is connected, preferably permanently, to the contact element, and for the contact element and the supporting element to be formed of mutually different materials or material compositions and for the contact element to be softer than the supporting element.

A basic concept of the invention is thus for the grounding element to be of at least two-part construction, that is to say for it to be constructed from at least one contact element and at least one supporting element, wherein these two elements consist of different materials or material compositions and have different degrees of hardness. The relatively soft contact element means that in particular also the development of particles, which is undesired in vacuum technology, as a result of abrasion when the valve is being opened and closed can be reduced further. The relatively hard supporting element ensures that the grounding element can be used over a long period of time and maintains its shape even over a relatively long period of time in the useful state. It should also be noted here that the supporting element, rather than being part of the carrier component, is an element which can be assigned to the grounding element and is connected to the contact element, in a permanent and fixed manner preferably throughout the operation of the valve. However, in preferred embodiments, it is possible for the supporting element to be fastened, or at least supported, on the carrier component, in a permanent and fixed manner preferably throughout the operation of the valve, by way of a side which is located opposite the contact element. The contact element may be the part of the grounding element which, in the closed position of the closure member, abuts in an electrically conductive manner against an abutment component of the valve in order to ground the closure member, whereas, in at least one open position of the closure member, this being different from the closed position, it is raised off from the abutment component. The abutment component here is a valve component other than the carrier component. Like the carrier component, however, it may also be the closure member, the supporting member, the valve seat or the abutment seat. Different pairings are therefore possible here. For example it is possible for the abutment component to be the valve seat and for the carrier component to be the closure member, or vice versa. An example of another pairing is the carrier component being the supporting member and the abutment component being the abutment seat. This arrangement is also possible the other way around. In contrast to the prior art, at any rate, it is advantageously provided that the contact element of the invention is not arranged, or fastened, directly on the carrier component.

It is possible for the closure member, in its closed position, to be connected in an electrically conductive manner, via the grounding element, to a correspondingly grounded component of the valve, and thus to be grounded itself. The correspondingly grounded component of the valve may be a housing of the valve. The valve seat and/or the abutment seat may be part of the housing of the valve.

In preferred embodiments, the closure member and/or the supporting member may be configured in the form of plates. In preferred embodiments, the valves according to the invention are so-called transfer valves which serve for closing through-openings in process chambers in which highly sensitive components, e.g. printed circuit boards and the like, are processed under a certain process atmosphere and, in particular, under negative pressure or a vacuum. In particular, valves according to the invention are used in so-called vacuum technology and are thus referred to as vacuum valves. Vacuum technology usually operates at pressures of smaller than or equal to 0.001 mbar or 0.1 pascals.

During operation of the valve, the grounding element is fastened advantageously in a permanent manner on the carrier component. This means that the grounding element, regardless of whether the closure member is located in the closed position or an open position, is always fastened on the carrier component. However, this does not mean that the grounding element cannot be fastened in a releasable manner on the carrier component, e.g. in order to carry out maintenance or changeover work. Preferred embodiments in this context provide for the supporting element of the grounding element to be screw-connected or clamped on the carrier component. During operation of the valve, the contact element and the supporting element, advantageously likewise irrespective of the position of the closure member, are connected to one another in a likewise permanent manner. Particularly preferred embodiments provide for the contact element to be vulcanized onto the supporting element. It is also conceivable, however, for the contact element to be fastened on the supporting element in some other way, e.g. by adhesive bonding, clamping, screw-connection and the like.

The supporting element advantageously has a metal or is formed of a metal. The term metal here, in principle, also covers metal alloys. Aluminum or stainless steel are examples of particularly preferred metals for this purpose. The tensile strengths of the supporting element are advantageously between 200 and 700 N/mm², and the Brinell hardness of the supporting element is advantageously at least 65 HB, preferably above. In order to ensure the desired grounding effect of the grounding element, the supporting element advantageously has a specific ohmic resistance of smaller than 5 times 10⁻⁵ ohm*cm, preferably smaller than 5 times 10⁻⁶ ohm*cm.

In order for the contact element to be of appropriately soft design, preferred embodiments provide for the contact element to have, or consist of, an elastomer. In order to provide the contact element with an appropriately good level of electrical conductivity for the desired grounding effect, provision may be made for the contact element to be a mixture of at least one elastomer and at least one additive for providing a low specific ohmic resistance for the contact element. The specific ohmic resistance is advantageously smaller than 10 ohm*cm, preferably smaller than 5 ohm*cm. The specific ohmic resistance of the contact element particularly preferably ranges between 0.002 and 5 ohm*cm. The elastomer used for the contact element is preferably rubber or silicone. Particularly preferred types of rubber are fluorinated rubber (FKM) or perfluorinated rubber (FFKM). The additive may be, for example, metal powder or carbon-containing powder. Suitable metals here are silver, aluminum, nickel, silver-plated copper, etc. The carbon-containing powder advantageously is formed of carbon nanotubes or carbon fibers. In order to configure the contact element with a suitable degree of softness, it advantageously has a Shore hardness of 40 Shore A to 90 Shore A, particularly preferably of 70 Shore A to 90 Shore A. The contact element may be in the form of a relatively thin layer on the supporting element. In this context, preferred variants provide for the contact element, at least in the main direction of loading, to have a thickness between 0.4 mm and 3 mm. The main direction of loading here is the direction in which, when the closure member is being pushed onto the valve seat, the largest forces act on the contact element from the outside.

All of the aforementioned parameter details relate to normal conditions.

In particularly preferred embodiments of the invention, the grounding element performs not just the grounding function, but also a supporting function. In this context, particularly preferred variants provide for the supporting member, in the closed position of the closure member, to be supported on the abutment seat by means of the grounding element or a plurality of grounding elements.

### BRIEF DESCRIPTION OF THE DRAWINGS

Further features and details of preferred embodiments of the invention will be explained with reference to the following description of the Figures, in which:

FIGS. 1 to 3 show a first exemplary embodiment of a valve according to the invention, wherein FIG. 1 shows the closed position, FIG. 2 shows an intermediate position and FIG. 3 shows the fully open position;

FIG. 4 shows a variant of a valve according to the invention which is modified in relation to said first exemplary embodiment;

FIGS. 5 to 9 show a first variant of a grounding element according to the invention, as can be used for the valves outlined above; and

FIGS. 10 to 13 show, by way of example, a second embodiment of grounding elements according to the invention.

### DETAILED DESCRIPTION OF THE PREFERRED EMBODIMENTS

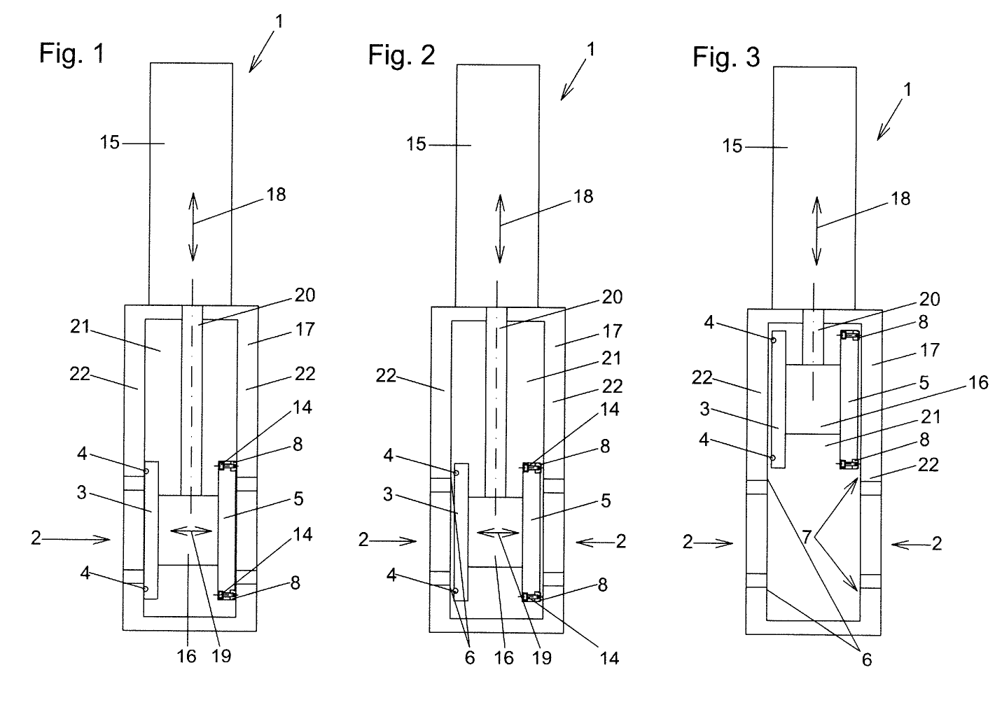

The first exemplary embodiment of a valve 1 according to the invention is shown in the closed position in FIG. 1. In this position, the closure member 3 seals the through-opening 2 of the valve 1, with the interposition of the seal 4 against the valve seat 6. In order for it to be possible to apply the appropriate forces, the supporting member 5 is supported on the abutment seat 7 of the valve 1. The seal 4 usually is formed of electrically insulating material. In the exemplary embodiment shown, the valve seat 6 and the abutment seat 7 are parts of the valve housing 17. They both enclose in each case a through-opening 2 through the valve 1. Both gaseous media and components which are to be processed in a process chamber can be introduced into the process chamber (not illustrated here), and removed again therefrom, through said through-opening 2, which is formed overall in the manner given above. The through-opening 2 of the valve 1 here is arranged such that it coincides with a corresponding removal and filling opening of the process chamber. This is known per se and need not be shown again. As realized in the exemplary embodiment shown, provision may be made for the closure member 3 and the supporting member 5 to be located within an interior space 21 of the valve 1. This interior space 21 is bounded by the side walls 22 of the housing 17. The through-openings 2 are located in said side walls 22. In the exemplary embodiment shown, and also in other preferred variants, both the valve seat 6 and the abutment seat 7 are formed on said side walls 22.

FIG. 2 shows an intermediate position of the closure member 3, in which the latter is no longer abutting in sealing fashion against the valve seat 6, although it still coincides with the through-opening 2. This is thus an open position.

A transverse drive 16 which is known per se is provided in order to move the closure member 3 back and forth between the closed position according to FIG. 1 and the intermediate position according to FIG. 2. The closure member 3 is pushed onto the valve seat 6, with the interposition of the seal 4, by a relative movement between the closure member 3 and supporting member 5, by means of the transverse drive 16, which acts in the transverse direction 19. In the closed position according to FIG. 1, the supporting member 5 then, in turn, is supported correspondingly on the abutment seat 7.

A longitudinal drive 15 is provided in order to move the closure member 3, together with the supporting member 5, from the intermediate position according to FIG. 2 into the fully open position according to FIG. 3, and in the opposite direction, and, by means of said longitudinal drive 15, the components arranged on the valve rod 20—the closure member 3, the supporting member 5 and the transverse drive 16—are moved in the longitudinal directions 18.

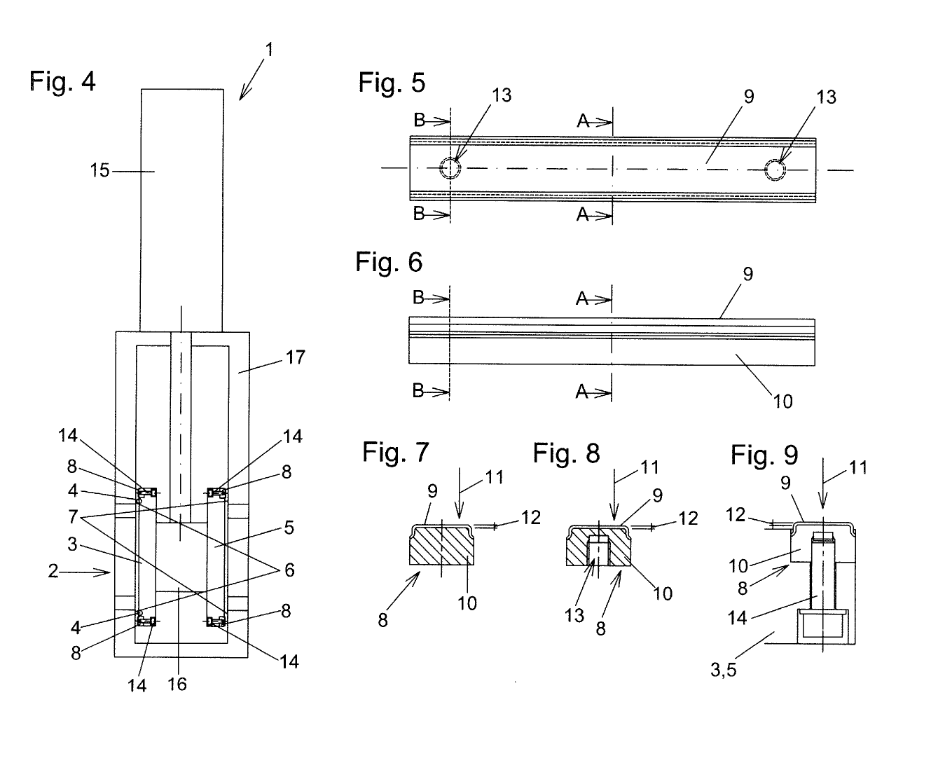

Overall, the valve in this first exemplary embodiment according to FIGS. 1 to 3, and in the second exemplary embodiment according to FIG. 4, is a so-called L valve, in which the closure member 3 follows an overall L-shaped movement path on its route from the fully open position into the closed position, and vice versa. A multiplicity of suitable drives for the longitudinal drive 15 and the transverse drive 16 are known in the prior art. These may be, for example, electric, pneumatic, hydraulic and/or combined drives, e.g. tapered-surface transmissions and the like. There is no need for these to be explained any further here, since various embodiments thereof can be found in the prior art.

In respect of the closure member 3 and/or also the supporting member 5, it should be noted that these are advantageously in the form of plates here. The length of the closure member 3 and/or of the supporting member 5, said length being perpendicular to the plane of the drawing and not being visible in FIGS. 1 to 4, is advantageously greater than the height of the closure member 3 and/or the supporting member 5, said height being visible in the plane of the drawing in the Figures.

For the sake of completeness, it should be noted that valves 1 according to the invention may be designed, of course, not just in the form of a so-called L valve, but also in the form of a pendulum valve. Other types of valve may also be provided according to the invention.

According to the invention, the first exemplary embodiment according to FIGS. 1 to 3 has grounding elements 8. In the exemplary embodiment according to FIG. 1, the supporting member 5 forms the carrier component on which the grounding elements 8 are fastened in a permanent manner, by means of their supporting elements 10, during operation of the valve 1. The configuration of the grounding elements 8 used in the first exemplary embodiment according to FIGS. 1 to 3, and also in the second exemplary embodiment according to FIG. 4, is shown more specifically in FIGS. 5 to 9 and is explained in detail hereinbelow. It should be said, in any case, that, in the exemplary embodiment according to FIG. 1, the abutment component of the valve 1 is formed by the abutment seat 7. The contact element 9 of the grounding element 8, in the closed position of the closure member 3 according to FIG. 1, butts in an electrically conductive manner against the abutment component, in the form of the abutment seat 7, in order to ground the closure member 3, whereas, in the open positions according to FIGS. 2 and 3, the contact element 9 is raised off from the corresponding abutment component. In this variant according to FIG. 1, the closure member 3 is thus grounded via the supporting member 5 and the grounding elements 8 fastened thereon and via the housing 17 of the valve 1. In this exemplary embodiment, the grounding elements 8 have a double function. On the one hand, they serve for the already mentioned purpose of electrical grounding. On the other hand, the supporting member 5, in the closed position of the closure member, is also supported on the abutment seat 7 by means of the grounding elements 8. Indeed, it is also necessary for the grounding elements 8, for this double function, to be appropriately resistant to pressure, in order to ensure that this configuration of the valve according to the invention operates over a long period of time. This is realized to particularly good effect by the two-part construction of the grounding element 8 in the form of a contact element and of a supporting element 10 connected thereto.

In the second exemplary embodiment according to FIG. 4, grounding elements 8 according to the invention are fastened directly on the closure member 3 by means of their supporting elements 10. The closure member 3 is therefore the carrier component in this case. The valve seat 6 forms the corresponding abutment component, against which the contact elements 9 butt only in the closed position of the closure member 3, in order to ground the latter. The arrangement of the seal 4 and of the grounding elements 8, likewise arranged on the closure member 3, should be selected so as to ensure that, when the closure member 3 is being pushed onto the valve seat 6, the seal 4 is deformed to a sufficiently pronounced extent in order to achieve the required level of sealing. This can be achieved, for example, by the seal 4, in the non-loaded state, that is to say in an open position, projecting from the front closing plane of the closure member 3 to a greater extent than the contact elements 9 of the grounding elements 8. The grounding elements 8 arranged on the supporting member 5 in this exemplary embodiment according to FIG. 4 have the same double function as in FIG. 1, that is to say, they serve, on the one hand, for supporting purposes and, on the other hand, for grounding purposes. In one modified embodiment of the variant according to FIG. 4, it would also be possible, however, for said grounding elements 8 arranged on the supporting member 5 to be replaced by straightforward supporting feet, which do not serve for grounding purposes, in particular when sufficient grounding is ensured via the grounding elements 8 directly on the closure member 3.

The grounding element 8 according to the invention as used in the exemplary embodiments of the valve 1 according to FIGS. 1 to 4 is shown, then, in FIG. 5 in a plan view of the contact element 9. FIG. 6 shows a side view, in which it is also possible to see to good effect the supporting element 10 of the grounding element 8, said supporting element being located beneath the contact element 9. It can be gathered to particularly good effect from FIGS. 5 and 6 that grounding elements 8 according to the invention are designed preferably in the form of strips, that is to say of elongate bodies. This is not absolutely necessary, however; the length and width of the grounding element 8 may also be more or less equal.

FIG. 7 shows the section taken along section line A-A, and FIG. 8 shows the section taken along section line B-B in the region of a blind hole 13 which serves for fastening purposes. In particular the sectional illustration according to FIGS. 7 and 8 show to good effect how the contact element 9 is connected, preferably in a permanent manner, to the supporting element 10. It is particularly preferred for the contact element 9 to be applied to that surface of the supporting element 10 which, in the operating position, is directed away from the respective carrier component. This application or fastening operation advantageously takes place by the contact element 9 being vulcanized onto the supporting element 10. The contact element 9 here may form a relatively thin layer, of which the thickness 12 in the main direction of loading 11 is advantageously, as stated at the outset, between 0.4 mm and 3 mm. In respect of the preferred materials, specific ohmic resistances and degrees of hardness, reference is made to the introduction of the description, so as to avoid repetition.

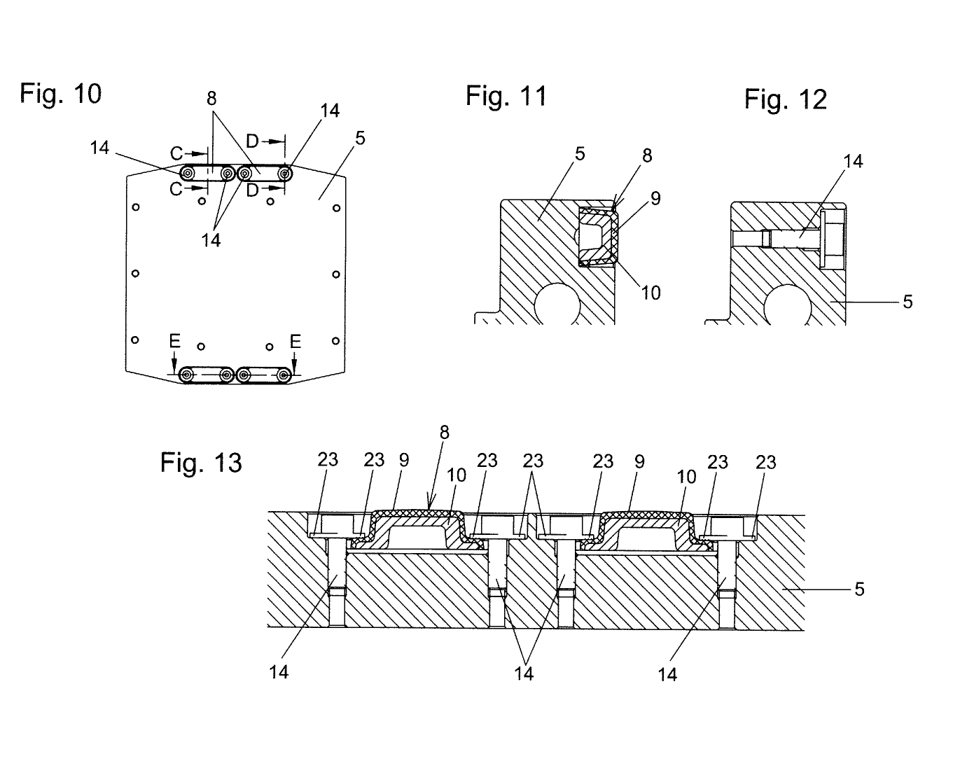

The blind hole 13 serves for fastening the grounding element 8 on the respective carrier component by means of its supporting element 10. This fastening takes place as illustrated in FIG. 9, advantageously by means of screw-connection, by the screw 14 being screwed into the blind hole 13, which carries a corresponding thread. The blind hole 13 is advantageously vented, during the screw-connection operation of the screw 14, via an appropriate venting channel (not illustrated here) through the screw 14. In the ready fastened arrangement illustrated on an enlarged scale in FIG. 9, the contact element 9 is oriented away from the carrier component, realized here in the form of the supporting member 5 or of the closure member 3, in the direction of the abutment component, which, as shown in FIGS. 1 to 4, may be formed for example by the valve seat 6 or the abutment seat 7. For the sake of completeness, it should be noted that the contact element 9 may also have a curved or convex contact surface. The latter advantageously has its convexity oriented in the direction of the abutment component. This convexity is then correspondingly deformed during the pushing-on operation.

Whereas the grounding element 8 according to the invention in this first exemplary embodiment is fastened on the corresponding carrier component by means of screw-connection, FIGS. 10 to 13, in a further exemplary embodiment, show how the grounding elements 8 according to the invention can be fastened with clamping action on the corresponding carrier component, e.g. once again in the form of the closure member 3 or of the supporting member 5. FIG. 10 shows a carrier component in the form of a supporting member 5, on which grounding elements 8 according to the invention are retained with a clamping action by means of the screws 14. FIG. 11 shows the section CC, FIG. 12 shows the section DD and FIG. 13 shows the section EE from FIG. 10. It is also the case in this exemplary embodiment that the supporting element 10 is at least supported on the corresponding carrier component by way of a side which is located opposite the contact element 9. For fastening purposes, the screws 14 clamp the grounding element 8 against the carrier component by way of their widened collars 23. The collars 23 may also be designed in the form of washers.

### KEY TO THE REFERENCE SIGNS

1 Valve

2 Through-opening

3 Closure member

4 Seal

5 Supporting member

6 Valve seat

7 Abutment seat

8 Grounding element

9 Contact element

10 Supporting element

11 Main direction of loading

12 Thickness

13 Blind hole

14 Screw

15 Longitudinal drive

16 Transverse drive

17 Housing

18 Longitudinal direction

19 Transverse direction

20 Valve rod

21 Interior space

22 Side wall

23 Collar

1. A valve, comprising:
at least one through-opening, at least one closure member, at least one seal, at least one supporting member, at least one valve seat and at least one abutment seat, the closure member, in a closed position thereof, seals the through-opening, with the seal interposed between the closure member and the valve seat, and is movable into the closed position by a relative movement between the closure member and the supporting member, the supporting member, in the closed position of the closure member, is supported on the abutment seat,
at least one grounding element that electrically grounds the closure member in the closed position, the grounding element fastened on a carrier component of the valve, the carrier component comprises at least one of the closure member, the supporting member, the valve seat or the abutment seat, and the grounding element has at least one contact element and at least one supporting element connected to the contact element, and the contact element and the supporting element are formed of mutually different materials or material compositions and the contact element is softer than the supporting element.

2. The valve as claimed in claim 1, wherein the supporting element is supported on the carrier component by a side thereof which is located opposite the contact element.

3. The valve as claimed in claim 1, wherein the contact element, in the closed position of the closure member, abuts in an electrically conductive manner against an abutment component of the valve to ground the closure member, and, in at least one open position of the closure member that is different from the closed position, is raised off from the abutment component, and the abutment component is at least one of the closure member, the supporting member, the valve seat, or the abutment seat that is a component other than the carrier component.

4. The valve as claimed in claim 1, wherein the supporting element includes or is formed of at least one metal.

5. The valve as claimed in claim 4, wherein the metal is aluminum or stainless steel.

6. The valve as claimed in claim 1, wherein the contact element includes or is formed of an elastomer.

7. The valve as claimed in claim 1, wherein the contact element is formed of a mixture of at least one elastomer and at least one additive for providing a low specific ohmic resistance for the contact element.

8. The valve as claimed in claim 7, wherein the elastomer includes or is formed of a rubber

9. The valve as claimed in claim 8, wherein the rubber is a fluorinated rubber, a perfluorinated rubber, or silicone.

10. The valve as claimed in claim 7, wherein the additive includes or is formed of a metal powder or a carbon-containing powder.

11. The valve as claimed in claim 1, wherein the contact element is vulcanized onto the supporting element.

12. The valve as claimed in claim 1, wherein the contact element has a Shore hardness of 40 Shore A to 90 Shore A.

13. The valve as claimed in claim 1, wherein the contact element has, in a main direction of loading, a thickness ranging from 0.4 mm to 3 mm.

14. The valve as claimed in claim 1, wherein the supporting member, in the closed position of the closure member, is supported on the abutment seat by the grounding element or a plurality of grounding elements.
